(19) United States
(12) Patent Application Publication
(10) Pub. No.: US 2021/0291116 A1
(43) Pub. Date: Sep. 23, 2021

(54) Membrane with enhanced potting material

(71) Applicant: Nanostone Water GmbH, Halberstadt (DE)

(72) Inventors: Anke-Gundula Roth, Halberstadt (DE); Christian Goebbert, Eschau (DE)

(21) Appl. No.: 17/338,321

(22) Filed: Jun. 3, 2021

Related U.S. Application Data
(63) Continuation of application No. PCT/EP2019/086824, filed on Dec. 20, 2019.
(60) Provisional application No. 62/783,990, filed on Dec. 21, 2018.

(51) Int. Cl. B01D 63/06; B01D 63/02; B01D 71/02

(52) U.S. Cl. CPC B01D 63/061; B01D 71/02; B01D 63/023

(57) ABSTRACT

In some embodiments, a filter membrane module includes at least one ceramic filter element made of a sintered, porous, ceramic structure, a potting material for potting the ceramic filter element, the potting material having an uncured state and a cured state, and a housing, wherein the potting material is a thermoplastic or a thermosetting plastic that in the cured state has a tensile strength in the range of about 2-65 MPa and a thermal expansion coefficient in the range of about 55-260×10−6/K, and a penetration depth of the potting material into the structure of the filter element is in the range of 0.24 mm to 3.0 mm, and a shrinkage after curing is less than 1.24%.

### RELATED APPLICATIONS

This application is a bypass continuation application of PCT Application Number PCT/EP2019/086824, filed Dec. 20, 2019, which claims priority to U.S. Provisional Application No. 62/783,990, filed Dec. 21, 2018. The entire disclosure of these applications is incorporated by reference herein.

### TECHNICAL FIELD

The disclosure relates to a filter membrane module, and a ceramic filter element having enhanced tensile strength, hardness, glass transition temperature, and polymer chain length.

### BACKGROUND

A filter membrane module generally has a substantially cylindrical housing in which a so-called monolith is arranged. The monolith in turn has a plurality of flat and relatively thin filter elements arranged substantially parallel and at a relatively small distance from each other within the housing, fixed by a potting material. The filter elements are traversed in their longitudinal direction by a plurality of filtration channels, which extend from one end face to the other end face of the filter elements. The filter elements are made of an open-pored ceramic material and have a porous ceramic structure. The inner walls of the filtration channels or the outside of the filter elements usually have a thin ceramic layer forming a filter membrane.

EP 3 153 228 A1 describes a potting material whose mass changes in a maximally permissible manner under given conditions. EP 1 803 756 A1 further describes a polyurethane resin which can be used as potting material.

### SUMMARY

A filter membrane's filter elements are mechanically fixed relative to each other by potting material. To achieve this arrangement, the filter elements are first positioned by an auxiliary device relative to each other, and then a liquid potting material is poured. For example, the material is poured into a mold having a cup-like cylindrical shape (e.g., a silicone material) at an end region of the filter elements. The filter elements are enclosed by the potting materials on their outsides, but without wetting the filter elements' end surfaces which are covered, for example by a silicone pad. After curing the potting material, a disk-shaped potting body is placed with the end portions of the filter elements immovably mechanically received or held within. The potting body and filter elements belong to the monolith mentioned above.

For normal operation, the filter elements' end faces should be tightly sealed to liquid and gas to prevent a liquid being filtered from unintentionally entering through the end faces of the filter elements. In quality tests, a fluid-tight and gas-tight seal is tested so that fluid that is pressed into the filtration channels does not exit through the end faces but passes through the open-pored material of the filter element to the outside thereof. For this purpose, a potting material is also used, which is applied, for example, by dipping or by rolling it in liquid form on the end faces and which forms a dense coating of the end face after curing.

In operation, a liquid to be filtered is pressed through the filtration channels of the filter elements. Contaminants (retentate) then deposits within the filtration channels on the filter membrane, whereas the purified liquid (permeate or filtrate) passes through the filtration membrane and the open-cell ceramic material of the filter elements and exits on the outside thereof. The potting body (or casting body) made of the potting material provides a seal between the liquid to be purified and the purified liquid (the permeate). In addition, the potting body supports the filter elements within the housing.

The potting material is subjected to mechanical, hydraulic, and chemical loads during operation. The cured potting material should withstand these stresses throughout the life of a filter membrane module. Further, it is desirable that the potting material in the liquid state is so fluid that it flows into narrow and small spaces between the filter elements. In addition, when the potting material in is the liquid state, the corresponding surfaces of the filter elements should be sufficiently wetted so that after curing an absolutely fluid-tight and gas-tight connection is formed between the cured potting material and the filter elements.

In some embodiments, a filter membrane module includes at least one ceramic filter element made of a sintered, porous, ceramic structure, a potting material for potting the ceramic filter element, the potting material having an uncured state and a cured state, and a housing, wherein the potting material is a thermoplastic or a thermosetting plastic that in the cured state has a tensile strength in the range of about 2-65 MPa and a thermal expansion coefficient in the range of about 55-260×10−6/K, and a penetration depth of the potting material into the structure of the filter element is in the range of 0.24 mm to 3.0 mm, and a shrinkage after curing is less than 1.24%.

Implementations can include one or more of the following. The potting material is an epoxide or polyurethane. The potting material in the uncured state has a viscosity that is in a range of about 400-4500 mPa·s. The potting material in the cured state has a Shore hardness in the range of about D10-D86. The potting material in the cured state has a Young's modulus in the range of about 20-4000 MPa. The potting material in the cured state has a glass transition temperature in the range of less than about 0° C. or greater than about 25° C. The potting material has a pot life in the range of about 7-180 min. The potting material in the cured state has an elongation in the range of about 1-10 or about 70-100. The potting material in the cured state has a cohesive fracture behavior with respect to itself and other bonded materials. After immersion of the potting material in the cured state in a fluid at a temperature of 55° C. for 18.5 days a change in mass is 5±2% or less, and/or a change in Shore hardness is ±22% or less, and/or a change in dimensions is ±7.0% or less, and/or a change in Young's modulus is ±18% or less, and/or a change in tensile strength is ±15% or less. The potting material comprises polyisocyanate and at least one diol and/or at least one polyol.

In some embodiments, a ceramic filter element includes at least two oppositely arranged end surfaces having filtration channels, and a surface covered with a potting material, wherein the potting material is an epoxy or polyurethane comprising a thermoplastic plastic or a thermosetting plastic, has a depth of penetration into the filter element in the range of 0.24 mm to 3.0 mm, a shrinkage after curing of less than 1.24% and when cured a tensile strength in the range of about 2-65 MPa and a thermal expansion coefficient in the range of about 55-260×10−6/K.

Implementations can include one or more of the following. At least one end face is sealed tightly against fluid and/or gas by the potting material. A plurality of ceramic filter elements mechanically connected by the potting material. The ceramic filter element has a segmental shape, monolithic shape, tubular shape, hollow fiber shape, or plate shape.

In some embodiments, a method of forming a filter membrane module, the filter membrane module comprising at least one ceramic filter element made of a sintered, porous, ceramic structure, a potting material for potting the ceramic filter element, the potting material having an uncured state and a cured state, and a housing, wherein the potting material is a thermoplastic or a thermosetting plastic that in the cured state has a tensile strength in the range of about 2-65 MPa and a thermal expansion coefficient in the range of about 55-260×10−6/K, and a penetration depth of the potting material into the structure of the filter element is in the range of 0.24 mm to 3.0 mm, and a shrinkage after curing is less than 1.24%, the method including filling a vessel with a mixture including an epoxy or polyurethane comprising a thermoplastic plastic or a thermosetting plastic, mechanically agitating the mixture for at least 5 minutes at 22° C., degassing the mixture at 60 mbar for about 8-10 minutes, curing the mixture at 60° C. for 8 hours, curing the mixture for 24 hours at room temperature.

Implementations can include one or more of the following. Transferring the degassed mixture to a clean mixing vessel. Mechanically agitating the mixture in the clean mixing vessel for 3-5 minutes. The mixture comprises diphenylmethane-4,4′-diisocyanate and polyether polyol. The mixture comprises methylenediphenyl diisocyanate, an aromatic isocyanate prepolymer, and polypropylene glycol. The mixture comprises diphenylmethane-2,4′-diisocyanate, diphenylmethan-4,4′-diisocyanate, diphenylmethane diisocyanate, and polyether polyol. The mixture comprises diphenylmethane-2,4′-diisocyanate, diphenylmethane-4,4′-diisocyanate, diphenylmethane diisocyanate, triethyl phosphate and diphenyl tolyl. The mixture comprises 1,1′-methylene-diphenyl-diisocyanate, 1,1′-methylenebis(4-isocyanatobenzene) homopolymer and vegetable oil. The mixture comprises a combination of Bisphenol A-epichlorohydrin resin and butane.

A filter membrane module includes a ceramic filter element of a sintered, porous and ceramic structure, a housing, and a potting material. The potting material is used for potting the ceramic filter elements, for mechanical fixing and/or sealing the end surface. The potting material comprises a thermoplastic or thermoset material, such as an epoxy or polyurethane. Optionally, it can include Poly I diisocyanate and diols or polyols. Examples of polyisocyanates are dipenylmethandiisocyanates such as, for example, diphenylmethan-4,4′-diisocyanate, diphenylmethan-2,4′-diisocyanate, 2,2′-methylenediphenyl-diisocyanate, 1,1′-methylene-diphenyl-diisocyanate, isocyanic acid with polymethylene-polyphenylene ester, o-(p-isocyanatobenzyl)phenylisocyanate, 4-methyl-m-phenylene diisocyanate, 1,1′-methylenebis(4-isocyanatobenzene) homopolymer and others. It is also possible to add triethyl phosphate and diphenyltolylphosphate. Typical polypropylenglycols are 1,1′, 1″,1′″-ethylenedinitrolotetrapropan-2-ol, 2-ethyl-1,3-hexanadiol, polyether polyols, polyester polyols, propoxylated amines. To obtain a good mixture, the diisocyanates can be homogenized with polypropylene glycol derivatives.

Generally, a penetration depth of the potting material into the ceramic structure of the filter elements is in the range of about 0.24 mm to about 3.0 mm. Shrinkage of the potting material after curing relative to its state before curing is in a range of less than about 1.24%.

The potting material has a tensile strength in the range of about 2-65 MPa and a thermal expansion coefficient in the range of approximately 55-260×10⁻⁶/K. The stated material properties refer to a fully cured state of the potting material.

Both ISO 527-1/527-2 and ASTM D638 specify tensile test methods for the determination of tensile strength. Both standards are technically equivalent, but do not yield completely comparable results, since the sample shapes, the test speeds and the method of determining the results differ in some respects. The values indicated and claimed here refer to test methods according to the ISO standard mentioned above, including plastics—Determination of tensile properties—Part 1: General principles and plastics—Determination of tensile properties—Part 2: Test conditions for molding and extrusion compounds.

In the standardized tensile test, test results are shown in relation to a defined withdrawal speed on the test specimen. In practical use of a component or a structure, however, the stresses occurring can lie in a very wide range of deformation rates. Due to the viscoelastic properties of the polymers, changing mechanical strain rates normally result in different mechanical properties from those measured on a standardized test specimen. For this reason, the characteristic values determined in the tensile test are only of limited suitability for component design, but represent a very reliable basis for material comparison.

The values herein apply to ambient and boundary conditions of 23° C.±2° C. A high tensile strength means that the material yields only minimally even under high tensile forces. Due to the high weight of the ceramic filter membrane module, the potting material must hold at least the weight of the monolith under all desired conditions of use (e.g. pressure surges, filled filter membrane module, etc.).

The thermal expansion coefficient (or the “mean linear thermal expansion coefficient”) is measured in accordance with DIN 53752: 1980-12 Testing of plastics; Determination of the coefficient of linear thermal expansion and ISO 11359-3: 2002 Plastics—Thermomechanical analysis (TMA)—Part 3: Determination of penetration temperatures. For plastics, thermomechanical analysis (TMA) is useful for measuring the mean linear thermal expansion coefficient. Cylindrical or cuboid test specimens with plane-parallel measuring surfaces are used. A quartz stamp is used to apply a low load (0.1 to 5 g) and at the same time measure the thermal expansion via an inductive measuring system. The experimental set-up is located in an oven which is heated at a low heating rate (e.g. a heating rate of 3-5 K/min). On the basis of DIN 53752 or ISO 11359, a mean linear thermal coefficient of linear expansion (upper equation below) or a differential thermal coefficient of linear expansion (the lower equation) can be determined by the equation given below.

$$\overline{a} ( T ) = \frac{1}{{L}_{0}} \cdot \frac{{L}_{2} - {L}_{1}}{{T}_{2} - {T}_{1}} = \frac{1}{{L}_{0}} \cdot \frac{Δ L}{Δ T}$$

$$a ( T ) = \frac{1}{{L}_{0}} \cdot \frac{dL}{dT}$$

The differential thermal expansion coefficient is determined by the slope of the tangent to the dependence ΔL/L0. The value is always zero at the beginning of the experiment.

Generally, the difference in thermal expansion coefficient should be as low as possible between the to-be-bonded materials so that no additional forces act on the bond, even with large temperature variations (shear).

Generally, the potting material in the uncured state has a viscosity which lies in a range of approximately 400-4500 mPa·s. This has proved to be particularly favorable for processing and for achieving the penetration depth desired. To determine the viscosity, the usual and known normalized test methods can be used, with the temperature at approximately at 23±2° C.

The Shore A hardness scale is used for soft rubber and Shore C and D hardness scale for elastomers and also soft thermoplastics. Temperature plays a crucial role in determination of the Shore hardness, so that the measurements must be carried out within a restricted temperature interval of 23±2° C. in accordance with the standards. However, a tempering chamber can also be used to determine the temperature-dependent hardness. The thickness of the specimen should be at least 6 mm. The hardness is read off 15 seconds after the contact between the bearing surface of the hardness tester and the test specimen.

A higher Shore hardness is less preferable for potting materials. Low Shore hardness materials tend to have high moduli of elasticity and elongation. Soft materials, e.g., materials with a rather low Shore hardness, show the phenomenon of “creep”, i.e. they plastically deform in response to a constant load applied for a long time.

Generally, the potting material has a Shore hardness in the range of about D10-D86. For elastomers or thermoplastic elastomers and duromers, the Shore hardness is determined according to ISO 7619-1: 2010. In the Shore hardness test method, in conjunction with a measuring stand, an additional device is used to increase the precision of the test specimen to be measured with a contact pressure of 12.5±0.5 N for Shore A or 50±0.5 N for Shore D. The DIN ISO 7619-1 standard, which has been in force since 2012, extends the standardized Shore hardness test to include the Shore method AO (for low hardness values) and AM (for thin elastomer test specimens) and gives corrected values for the indenter geometry at Shore D (R=30±0.25°). When using a contact pressure and a stationary measuring stand, for Shore A 1+0.1 kg instead of 12.5±0.5 N is used and for Shore D a contact pressure of 5+0.5 kg instead of 50±0.5 N. At the same time, the measurement time is extended from 3 to 15 s in this new standard and the storage of the test specimens in standard climate was shortened from 16 to 1 h. For a secured hardness value, five individual measurements are now possible.

Young's modulus (E) is commonly used in mechanical engineering in the strength calculation of metals and plastics. Young's modulus is often referred to as Elastic Modulus, Tensile Modulus, Elasticity Coefficient, Elongation Modulus, or Young's Modulus. It is a parameter of how much a material yields when force is applied. With the same load and geometry, a rubber component will yield more than a steel component. Young's modulus is the proportionality constant between stress σ and strain ε of a solid material in the linear elastic range, i.e., the slope of the curve in the stress-strain diagram in the linear elastic range. If stress σ and strain ε of a material sample in the linear elastic range are known, Young's modulus E is determined as:

E=Δσ/Δε=const.

Young's modulus can also be determined graphically from the stress-strain diagram. The stress-strain diagram is a direct result of a tensile test. In the tensile test, a standard test material is subjected to stress and the occurring strain is then plotted on a chart. In the linear-elastic initial region of the curve, Young's modulus can be determined from the stress and the elongation. In the curve there is elastic deformation up to a yield point and then a plastic deformation up to a tensile strength. Once necking (e.g., plastic deformation) of the specimen begins and the maximum elongation is exceeded, fracture occurs.

Here, the values of Young's modulus refer to a temperature of 23±2° C. The modulus of elasticity decreases at higher room temperatures.

Young's modulus and the elongation should be as low as possible in the elastic range, and preferably not enter the range for plastic deformation. This improves the dimensional stability of the cured potting material.

The potting material has a Young's modulus in the range of about 50-4000 MPa. As mentioned above in connection with the determination of the tensile strength, both the ISO 527-1/527-2 and the ASTM D638 test methods for the tensile test are used. In the standardized tensile test, test results are shown in relation to a defined withdrawal speed of the test specimen. In practical use of a component or a structure, however, the stresses occurring can lie in a very wide range of the deformation rate. Due to the viscoelastic properties of the polymers, changing mechanical strain rates normally result in different mechanical properties from those measured on a standardized test specimen. For this reason, the parameters determined in the tensile test are only of limited suitability for component design, but provide a very reliable basis for a material comparison.

The potting material has an elongation in the range of about 1-10 or about 70-100. The elongation is generally detected by the probe. Strain gauges record how strong the strain is in a certain force range, from which the strain is calculated.

The glass transition temperature is determined according to ISO 11357-1: 2017-02. A heating speed of 20 K/min used. The test atmosphere used is nitrogen (N₂). ISO 11357 specifies various methods of differential scanning calorimetry (DSC) for the thermal analysis of polymers and polymer blends, such as: thermoplastics (polymers, molding compounds and products of compression molding with or without fillers, fibers or polymers, reinforcing materials); thermosets (hardened or uncured materials with or without fillers, fibers or reinforcing materials); elastomers (with or without fillers, fibers or reinforcing materials). ISO 11357 is used to observe and quantify various phenomena or properties of the above materials, such as: physical transformations (glass transition, phase transformations such as melting or crystallization, polymorphic transformations, etc.); chemical reactions (polymerization, crosslinking and vulcanization of elastomers and thermosets and so on); oxidation stability; and heat capacity.

The glass transition temperature should be outside the recommended operating temperatures of the membrane module. The properties of polyurethanes below and above the glass transition temperature are often significantly different, so a material above the glass transition temperature can be elastic and the same material below the glass transition temperature brittle.

The potting material has a glass transition temperature in the range of approximately less than 0° C. or greater than 25° C.

The potting material has a pot life in the range of about 7-180 min. The pot life (workability time) is determined according to DIN EN 14022: 2010-06. This standard specifies ways to determine the suitability and properties of adhesives, alternatively known as workability time and pot life. It lays down five procedures for determining the time available for application, each of which relates to particular circumstances; particularly important are the flow behavior of the adhesive in question and its reaction rate. The test standard is addressed to adhesive manufacturers, users of multi-component adhesives and independent testing laboratories. The values given above are for an ambient temperature of 23±2° C. and for a stable relative humidity, which is ideally around 35%.

The processing times are significantly dependent on the pot life and thus the pot life is also directly linked to the process times or throughput times. The material must flow enough so that it can be applied in narrow gaps between individual filter elements. Process times can then be adjusted by process parameters such as temperature.

An important parameter is also swelling. This parameter is determined by first determining the weight of a completely dry sample of the potting material, then immersing the sample of potting material, which need not have a particular shape, in a fluid, namely an aqueous solution, at 55° C. for 18.5 days. At the end of the 18.5 days, the weight of the sample is again determined. The equilibrium threshold Q is calculated according to:

$$Q = \frac{\frac{{W}_{P}}{{d}_{P}} + \frac{{W}_{S}}{{d}_{S}}}{( {W}_{P} / {d}_{P} )}$$

where W_{P} is the weight of the dry sample, Wₛ is the weight of the solution at equilibrium, dₚ is the density of the potting material and ds is the density of the solvent. The parameters used in the formula are measured at a temperature of 23±2° C.

The water absorption and swelling should be as low as swelling behavior indicates a penetration of solution (when testing a test solution, e.g. an aqueous solution or in the practical use of filtering water) into the plastic structure. If fluids with high or low pH values (e.g. pH 0 or pH 14, pH 2 or pH 12, etc.) are trapped in the structure in the long term, there is a risk that the material “ages” faster. Material parameters such as elongation, tensile Young's modulus, and Shore hardness also change with the swelling.

After immersing the cured potting material in a fluid at a temperature of 55° C. for 18.5 days, a change in the mass is ±2.5% or less, a change in Shore hardness is ±22% or less, a change in dimensions is ±7.0% or less, a Young's modulus change is ±18% or less, and a change in tensile strength is ±15% or less. For Shore hardness, height, length and weight, the change in these parameters between the samples immediately after aging without drying is compared with the values of the parameters after drying out (ideally equal to the initial values before aging) (non-destructive valuation). For Young's modulus and tensile strength the values after aging with drying are compared with values of samples that were not outsourced (non-destructive value determination).

The cured potting material has a cohesive fracture behavior with respect to the tensile shear properties over itself and other bonded materials. Such a fracture behavior also demonstrates favorable material properties.

It is possible for a potting material, which comprises polyisocyanate and diols or polyols, has a catalyst, in particular an organo-tin composite. As a result, the production of the potting material with the desired parameters is facilitated. This applies in particular if, as mentioned above, a diisocyanate is to be homogenized with propylene glycol derivatives.

The details of one or more embodiments are set forth in the accompanying drawings and the description below. Other features and advantages will be apparent from the description and drawings, and from the claims.

### DESCRIPTION OF DRAWINGS

FIG. 1 is a longitudinal section through a filter membrane module with a housing.

FIG. 2 is an enlarged longitudinal section through a portion of the filter elements of FIG. 1.

FIG. 3 is a cross section through an upper portion of the filter membrane module of FIG. 1 along line

Like reference symbols in the various drawings indicate like elements.

### DETAILED DESCRIPTION

A ceramic filter element has at least two oppositely disposed end faces. Filtration channels are present within the filter elements, extending in their longitudinal direction and opening into the end surfaces. A portion of the surface of the filter elements is covered with a potting material. Such a ceramic filter element has an optimum potting material on at least one surface.

At least one end surface is sealed in a fluid-tight and gas-tight manner by the potting material. In normal operation, this arrangement ensures that contaminated fluid does not enter the filter element through the end surfaces (following a flow path through the filter element from inside to outside). The contaminated fluid thus passes through the filter membrane present on the inner walls of the filtration channels only. In quality tests, such a fluid-tight and gas-tight seal ensures that, for example, air which is pressed into the filtration channels does not exit through the end faces but passes through the open-pored material of the filter element to the outside thereof.

Furthermore, each ceramic filter element belongs to a composite of several ceramic filter elements that are mechanically connected by the potting material. Curing the potting results in a long-lasting and stable mechanical composite of the filter elements.

The ceramic filter elements can have a segmental shape, monolithic shape, tubular shape, hollow fiber shape, or plate shape. Other shapes are also possible.

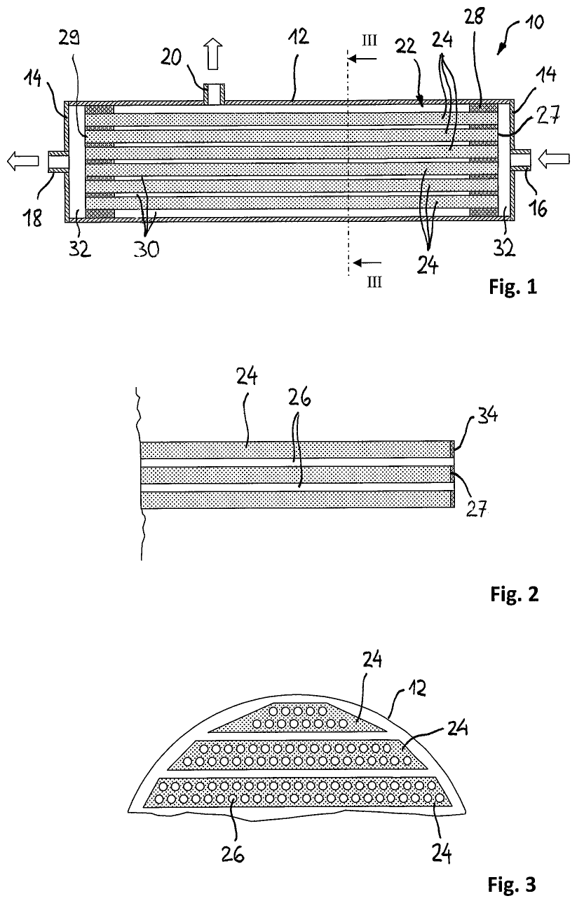

A filter membrane module 10 is shown in FIG. 1. The filter membrane module 10 comprises a tubular housing 12 with a circular cross section. Other cross sections are possible, for example rectangular, square, or polygonal cross sections. At the two axial ends of the housing 12 are disc-shaped covers 14 that are secured to be fluid-tight. The right-hand cover 14 comprises an inlet connection 16 for a fluid to be filtered, the left-hand cover 14 comprises an outlet connection 18 for an unfiltered fluid. The housing 12 has an outlet nozzle 20 for the filtered fluid (filtrate or permeate). The housing 12 and the covers 14 may be made of metal or of a plastic; for example, a fiber composite plastic.

A monolith 22 is within the housing 12. Shown in FIG. 1 are six flat filter elements 24, that is are elongate, vertically relatively wide in a direction perpendicular to the drawing plane and narrow in a direction up and down. Other cross sections of filter elements 24 are possible. The filter elements 24 are made of a sintered, porous ceramic material. The top three of these filter elements 24 are shown in plan view in FIG. 3. It can be seen that the outer shape of the filter elements 24 conform to the circular cross section contour of the housing 12, so that the inner volume of the housing 12 is optimally utilized. Overall, the filter elements 24 each have a trapezoidal cross-section.

As is also apparent from FIG. 3, a plurality of filtration channels 26 extend through the filter elements 24. In. FIG. 1, these filtration channels 26 extend from a front end face 27 of a filter elements 24 to the rear front end face 29 of the filter elements 24. For clarity, in FIG. 1 the reference numerals for the end-side end faces 27, 29 are shown for one filter element 24 only. The inner walls of the filtration channels 26 are coated with a ceramic filter membrane, not shown in the drawing.

The monolith 22 includes a potting body 28 at its respective end faces. The potting body is made from a liquid potting material that is cured. The filter elements 24 are mechanically fixed relative to each other by the cured potting material. The potting material generates a fluid-tight seal of inner fluid spaces 30 between the filter elements and of the outer fluid chambers 32 between the covers 14 and the potting body 28. To ensure a fluid-tight seal additional elements can be used, such as seals or the like.

To produce the potting body 28, the filter elements 24 are arranged in the desired manner; for example by an auxiliary device which is removed after the production of the potting body 28. The filter elements 24 are arranged so that their longitudinal direction extends in the axial direction. One end of the composite filter element 24 is placed in a cup-like mold of silicone material. The cup-like mold is then filled with a curable liquid, wrapping around the end portions of the filter elements 24 and completely wetting their outer surfaces. The curable liquid material is a material that hardens, or cures, over a certain time. After curing, the composite of filter elements 24 together with the cured material now forms the potting body 28, and is removed from the mold.

The curable material serves for production of the potting body 28, and for the end surface seal 34. FIG. 2 shows a section through an end region of a single filter element 24. The filtration channels 26 provide a right end portion of the corresponding right-hand front end face 27. The curable material is applied to the end face 27, for example, by rolling, brushing or spraying. After curing, the end surface seal 34 forms. As a result, it is prevented during operation that fluid to be filtered passes directly via the end-side end face 27 into the filter element 24 and from there to its outside, without having flowed through the filter membrane present on the inner wall of the filtration channels 26.

During operation, fluid to be filtered is introduced through the right inlet port 16 into the right outer fluid chamber 32. From there it flows through the filtration channels 26. Non-filtering material is not transmitted through the walls of the filtration channels 26 filter membrane but deposited there. The filtrate flows through the filter membrane and through the open-pored ceramic material of the filter elements 24 to collect in the inner fluid space 30 and flow through the outlet port 20. The unfiltered fluid may flow out through the outlet port 18 and be returned to the inlet port 16.

The potting material used for the production of the potting body 28 or for the end surface seal 34 is a plastic material and can be a thermoplastic or a duroplastic, e.g., an epoxide or polyurethane. The depth of penetration of the potting material into the structure of the filter elements 24 is in the range of about 0.24 mm to about 3.0 mm, with shrinkage after curing of less than about 1.24%. In the cured state, it has a tensile strength in the range of approximately 2-65 MPa and a thermal expansion coefficient in the range of about 55-260×10⁻⁶/K. Its Shore hardness can be in the range of about D10-D86, and Young's modulus in the range of about 50-4000 MPa. The glass transition temperature can be in the range of approximately less than 0° C. or greater than 25° C. Further, the potting material can have a pot life in the range of about 7-180 min, and an elongation in the range of about 1-10 or about 70-100. The hardened potting body 28 or the cured end surface seal 34 have a cohesive fracture behavior with respect to the tensile shear properties both with respect to itself and to other bonded or bonded materials.

Generally speaking, all equipment used for the production of liquid potting material should be intact, clean and dry. Oil, grease and other contaminants that affect adhesion should be removed. Oil-contaminated surfaces (e.g., silicone gaskets) that have absorbed oil should be suitably cleaned with an emulsifying detergent. Excess water should be removed from the equipment used. The starting material is used at suitable temperatures and should be placed in the processing area one to two days prior to use and stored there to allow for their adaptation to ambient conditions. At the time of dosing, the temperature of the starting material should not exceed 50° C. The reaction and processing times depend on the ambient temperature and the outlet temperature of the raw material from, and also on the relative humidity. At low temperatures, chemical reaction times are prolonged, extending pot life and processing time. Contact between starting material and water should be avoided until complete curing, as this may cause decarboxylation or tackiness on the surface, which in each case will cause the potting material to lose its properties.

The components should be thoroughly homogenized and all material scraped off the walls and bottom of the mixing container used. Mechanical or motorized mixing rather than manual mixing is possible, but should be at a low material access speed (e.g. 3 g/s at 25° C.), so that as little air as possible is introduced into the batch.

To obtain an even better chemical resistance of the potting material, the change in mass of a cured test sample of a polyurethane resin composition in a fluid (e.g. water, sodium hydroxide, sulfuric acid, glycerol or hypochlorite) at a temperature of 55° C. for 18.5 days should be ±2.5% or less. It is even better if the mass change for a test sample is ±2.0% or less. A higher change of mass due to a chemical stress can be an indication that the cured polyurethane casting material dissolves when it comes in contact with a fluid to be filtered, or may be an indication that the cured polyurethane casting material in operation absorbs a significant amount of water and thereby swells.

Also with respect to the chemical resistance, the change in Shore hardness of a test sample of a cured polyurethane composition after immersion in a liquid at a temperature of 55° C. for 18.5 days and after a subsequent drying of the test sample should be ±22% or less. Here and below (in the case of the further parameters mentioned below), the measurement of the respective change in value (Δ) takes place before the removal, directly after the removal in the non-dried state and after drying. With mean values from 10 samples being used, the Δ value is determined as follows:

Measured value (current)=XA, XB or XC

Mean value from measurement before removal=A

Mean value from measurement after aging and before drying=B

Mean value from measurement after aging and after drying=C

Mean value A=(XA₁+XA₂+XA₃ . . . +XAₙ)/n

Calculation of the mean value for B and C analogous to A.

The relative changes (d) for each individual measured value are then determined from the current measured values and the calculated average values.

dA=(XA−A)/A

From the relative changes of each individual measurement, the mean of the relative change is calculated.

$$\overline{dA} = \frac{{\sum }_{i = l}^{i = n} ( {XA}_{i} - A ) / A}{n}$$

Calculation of the relative changes (d) for each individual measurement for B and C analogous to dA.

Calculation of the mean value of the relative change d̅ for B and C analogous to d̅A̅

From the relative results, the absolute changes can now be calculated.

D1=d̅B̅−d̅A̅

D2=d̅C̅−d̅A̅

Δ mass, Δ Shore hardness, Δ length, Δ height:

Δ value=maximum value (D1, D2)

Δ Young's modulus, Δ tensile strength:

Δ value=maximum value D2

Ideally, the value before aging without drying corresponds to the value after aging with drying. Since a ceramic filter element in which the casting material is used, and thus the casting material itself is always operated in the liquid medium, this difference value is of interest.

A larger change of the Shore hardness due to chemical stress may be an indication that in operation when the polyurethane potting material comes into contact with fluid, the change in material properties results in certain required product specifications (for example, a resistance to pressure surges) being no longer complied with.

Also in view of the chemical resistance, a change in the dimensions (height and length) of a test sample of a cured polyurethane composition, after immersion in a chemical liquid at a temperature of 55° C. for 18.5 days without or with a subsequent drying of the test sample should be ±7.0% or less, e.g., ±2.5% or less. A larger change in dimensions due to chemical stress can cause irreversible damage to the filter membrane module due to elongation or shrinkage of the polyurethane potting materials leading to leaks of the filter membrane module either by damage to the filter elements or by a change in the adhesive properties between the different materials.

Also in terms of chemical resistance, a change in Young's modulus of a cured test sample of a polyurethane composition after immersion in a chemical fluid at a temperature of 55° C. for 18.5 days and after subsequent drying of the test sample should be ±18% or less. A greater change in Young's modulus due to chemical stress on the test sample can result in a change in material properties that is too high to meet certain product specifications, such as resistance to pressure surges.

Also in terms of chemical resistance, the change in tensile strength of a cured sample of a polyurethane composition after immersion in a chemical fluid at a temperature of 55° C. for 18.5 days and after subsequent drying of the test sample should be ±15% or less. A greater change in tensile strength due to chemical stress can result in a change in material properties in operation that is too high to meet certain product specifications, such as resistance to pressure surges.

### EXAMPLE 1

A container with a stirrer and a thermometer was charged with 39.7 parts by weight of diphenylmethane-4,4′-diisocyanate and 100.3 parts by weight of polyether polyol. The reaction was carried out at 22° C. The two components were fully homogenized, and the agitator was operated for at least 5 minutes. The mixture was then degassed at 60 mbar for about 8-10 minutes. The mixed and degassed components were transferred to a clean mixing container. There, the reaction was carried out for about 3-5 minutes with vigorous stirring to give a polyurethane resin solution. This was poured into coated molds. It was then cured at 60° C. for 8 hours. After cooling to room temperature, the polyurethane test samples were removed from the mold and then cured at room temperature for 24 hours. The test samples obtained in this way had the following properties (TCE=thermal expansion coefficient, Tg=glass transition temperature, and the Δ values describe the change in the respective property after immersion in a fluid (namely the test fluid described above with possibly different pH values) at a temperature of 55° C. for 18.5 days):

Density: 1.18 g/cm³

Pot life (200 g): approx. 50 minutes

Viscosity: 400-600 mPa·s

Shore hardness: D60

TCE: 117 ppm/K at T<30° C.

205 ppm/K at T>40° C.

Tensile strength: 6 MPa

Tg: 31° C.

Young's modulus: 890 MPa

Δ mass: +1.6%

Δ Shore hardness D: +3.3%

Δ length: +0.6%

Δ height: +2.2%

Δ Young's modulus: −12%

Δ tensile strength: +2.6%.

Here, as below, the pot life is large. This is due to the fact that any two-component curing takes place through an exothermic reaction that releases energy in the form of heat. The curing itself is temperature dependent. Thus, the larger the amount used, the more heat is released and the faster the two components cure. Conversely, the smaller the amount used, the longer the curing process takes.

### EXAMPLE 2

A vessel with a stirrer and a thermometer was charged with 50.5 parts by weight of a mixed combination of methylenediphenyl diisocyanate (concentration between 50-75%) and an aromatic isocyanate prepolymer (concentration between 25-50%) and 99.5 parts by weight of polypropylene glycol. The reaction was carried out at 22° C. The two components were fully homogenized by operating the agitator for at least 5 minutes. The mixture was then degassed at 60 mbar for about 8-10 minutes. The components thus premixed and degassed were transferred in their entirety to a clean mixing vessel. There, the reaction was carried out for about 3-5 minutes with vigorous stirring to give a polyurethane resin solution. This was poured into coated molds to make test samples. It was then cured at 60° C. for 8 hours. After cooling to room temperature, the polyurethane test samples were removed from the mold. This was post cured for an additional 24 hours at room temperature. The test samples thus obtained had the following characteristics (TCE=the thermal expansion coefficient; Tg=glass transition temperature; the Δ values describe the change in the respective property after immersion in a fluid (namely the above-described test fluid with possibly different pH values) at a temperature of 55° C. for 18.5 days):

Density: 1.08 g/cm³

Pot life (150 g): about 15 minutes

Viscosity: 1100-1300 mPa·s

Shore hardness: D58

TCE: 85 ppm/K at T<0° C.

206 ppm/K at T>50° C.

Tensile strength: 14 MPa

Tg: 36° C.

Young's modulus: 550 MPa

Δ mass: +1.7%

Δ Shore hardness D: +5.4%

Δ length: +0.38%

Δ height: +0.5%

Δ Young's modulus: −12%

Δ tensile strength: −14.3%.

### EXAMPLE 3

A container with a stirrer and a thermometer was charged with 50.5 parts by weight of diphenylmethane-2,4′-diisocyanate (concentration between 5-10%), diphenylmethan-4,4′-diisocyanate (concentration between 10-25%), diphenylmethane diisocyanate (concentration between 65-85%) and 100 parts by weight of polyether polyol. The first three components were premixed and added to the hardener as a homogeneous mixture. The reaction was carried out at 22° C. The two components were fully homogenized by operating the agitator for at least 5 minutes. The mixture was then degassed at 60 mbar for about 8-10 minutes. The components thus premixed and degassed were transferred in their entirety to a clean mixing vessel. There, the reaction was carried out for about 3-5 minutes with vigorous stirring to give a polyurethane resin solution. This was poured into coated molds to make test samples. It was then cured at 60° C. for 8 hours. After cooling to room temperature, the polyurethane test samples were removed from the mold and then cured at room temperature for 24 hours. The test samples obtained in this way had the following properties (TCE=the thermal expansion coefficient, Tg=glass transition temperature; the Δ values describe the change in the respective characteristic after immersion in a fluid (namely the above-described test fluid with possibly different pH Values) at a temperature of 55° C. for 18.5 days):

Density: 1.14 g/cm³

Pot life (150 g): approx. 60 minutes

Viscosity: 400-600 mPa·s

Shore hardness: D50

TCE: 116 ppm/K at T<25° C.

220 ppm/K at T>40° C.

Tensile strength: 10 MPa

Tg: 28° C.

Young's modulus: 230 MPa

Δ mass: +2.2%

Δ Shore hardness D: −12%

Δ length: +0.5%

Δ height: +2.4%

Δ Young's modulus: −18%

Δ tensile strength: −15%.

### EXAMPLE 4

A container with a stirrer and a thermometer was charged with 16 parts by weight of a mixed combination of diphenylmethane-2,4′-diisocyanate (concentration 25-50%), diphenylmethane-4,4′-diisocyanate (concentration of between 25-50%) and diphenylmethane diisocyanate (isomers and homologues, concentration of between 20-25%) and 100.2 parts by weight of a mixture of triethyl phosphate and diphenyl tolyl phosphate in a polyester/polyether polyol. The reaction was carried out at 22° C. The two components were fully homogenized by operating the agitator for at least 5 minutes. The mixture was then degassed at 60 mbar for about 8-10 minutes. The components thus premixed and degassed were transferred in their entirety to a clean mixing vessel. There, the reaction was carried out for about 3-5 minutes with vigorous stirring to give a polyurethane resin solution. This was poured into coated molds to make test samples. It was then cured at 60° C. for 8 hours. After cooling to room temperature, the test samples were removed from the mold and then cured at room temperature for 24 hours. The test samples obtained in this way had the following properties (TCE=the thermal expansion coefficient, Tg=glass transition temperature; the Δ values describe the change in the respective property after immersion in a fluid (namely the above-described test fluid with possibly different pH Values) at a temperature of 55° C. for 18.5 days):

Density: 1.52 g/cm³

Pot life (250 g): approx. 45 minutes

Viscosity: 600-900 mPa·s

Shore hardness: D40

TCE: 55 ppm/K at T<−20° C.

M/K at T>−5° C.

Tensile strength: 7 MPa

Tg: −4° C.

Young's modulus: 20 MPa

Δ mass: −2.1%

Δ Shore hardness D: −21%

Δ length: −1.1%

Δ height: −6.6%

Δ Young's modulus: −14.3%

Δ tensile strength: −4.7%.

### EXAMPLE 5

A container with a stirrer and a thermometer was with 54 parts by weight of a mixed combination of 1,1′-methylene-diphenyl-diisocyanate (concentration between 30-60%) and 1,1′-methylenebis(4-isocyanatobenzene) homopolymer (concentration between 10-30%) and 100 parts by weight of a polyol mixture consisting of 5-15% diols and 0.5-1.5% vegetable oil based on fatty acids. The reaction was carried out at 22° C. The two components were fully homogenized by operating the agitator for at least 5 minutes. The mixture was then degassed at 60 mbar for about 8-10 minutes. The components thus premixed and degassed became complete in quantity transferred to a clean mixing container. There, the reaction was carried out for about 3-5 minutes with vigorous stirring to give a polyurethane resin solution. This was poured into coated molds to make test samples. It was then cured for 16 hours at 80° C. After cooling to room temperature, the polyurethane test samples were removed from the mold and then cured at room temperature for 24 hours. The test samples obtained in this way had the following properties (TCE=thermal expansion coefficient, Tg=glass transition temperature, the Δ values describe the change in the respective property after immersion in a fluid (namely the above-described test fluid with possibly different pH values) at a temperature of 55° C. for 18.5 days):

Density: 1.05 g/cm³

Pot life (200 g): approx. 60 minutes

Viscosity: 2000 mPa·s

Shore hardness: D10

TCE: not measurable

Tensile strength: 6.2 MPa

Tg: −20° C.

Young's modulus: 150 MPa

Δ mass: +0.8%

Δ Shore hardness D: −14.3%

Δ length: −0.1%

Δ height: −2.5%

Δ Young's modulus: −10%

Δ tensile strength: +8.5%.

### EXAMPLE 6

A container with a stirrer and a thermometer was charged with 100 parts by weight of a mixed combination of Bisphenol A-epichlorohydrin resin (average molecular weight <700) and 1,4-bis (2,3-epoxypropoxy) butane and 50.2 parts by weight of a mixture of 3-Aminomethyl-3,5,5-trimethylcyclohexylamine (45-50%), alkyl polyamine (35-40%), polyaminoamide adduct (10-15%) and 1,2-diamino-ethane (1-5%) loaded. The reaction was carried out at 22° C. The two components were fully homogenized by operating the agitator for at least 5 minutes. The mixture was then degassed at 60 mbar for about 15 Minutes. The components thus premixed and degassed were transferred in their entirety to a clean mixing vessel. There, the reaction was carried out for about 5 minutes with vigorous stirring to give an epoxy resin solution. This was poured into coated molds to make test samples. It was then cured at 80° C. for 2 hours. After cooling to room temperature, the epoxy test samples were removed from the mold and then cured at room temperature for 24 hours. The test samples thus obtained had the following properties (TCE=the thermal expansion coefficient; g=glass transition temperature; the Δ values describe the change in the respective property after immersion in a fluid (namely the test fluid described above with possibly different pH values) at a temperature of 55° C. for 18.5 days):

Density: 1.08 g/cm³

Pot life (250 g): 120 minutes

Viscosity: 500-1000 mPa·s

Shore hardness: D80

TCE: 90 ppm/K at T<50° C.

190 ppm/K at T>60° C.

Tensile strength: 59 MPa

Tg: 52° C.

Young's modulus: 3800 MPa

Δ mass: +2.5%

Δ Shore hardness D: −8%

Δ length: +0.9%

Δ height: +1.25%

Δ Young's modulus: −4.3%

Δ tensile strength: −9.1%.

A number of embodiments have been described. Nevertheless, it will be understood that various modifications may be made without departing from the spirit and scope of the disclosure. Accordingly, other embodiments are within the scope of the following claims.
Following subject matter and aspects of the invention are described:
1. A filter membrane module, comprising:
at least one ceramic filter element made of a sintered, porous, ceramic structure;
a potting material for potting the ceramic filter element, the potting material having an uncured state and a cured state; and
a housing;
wherein the potting material is a thermoplastic or a thermosetting plastic that in the cured state has a tensile strength in the range of about 2-65 MPa and a thermal expansion coefficient in the range of about 55-260×10⁻⁶/K, and
a penetration depth of the potting material into the structure of the filter element is in the range of 0.24 mm to 3.0 mm, and a shrinkage after curing is less than 1.24%, and/or preferably, wherein the potting material is an epoxide or polyurethane, and/or preferably, wherein the potting material in the uncured state has a viscosity that is in a range of about 400-4500 mPa·s, and/or preferably, wherein the potting material in the cured state has a Shore hardness in the range of about D10-D86,and/or preferably wherein the potting material in the cured state has a Young's modulus in the range of about 20-4000 MPa, and/or preferably, wherein the potting material in the cured state has a glass transition temperature in the range of less than about 0° C. or greater than about 25° C., and/or preferably, wherein the potting material has a pot life in the range of about 7-180 min, and/or preferably, wherein the potting material in the cured state has an elongation in the range of about 1-10 or about 70-100, and/or preferably, wherein the potting material in the cured state has a cohesive fracture behavior with respect to itself and other bonded materials, and/or preferably, wherein after immersion of the potting material in the cured state in a fluid at a temperature of 55° C. for 18.5 days a change in mass is 5±2% or less, and/or a change in Shore hardness is ±22% or less, and/or a change in dimensions is ±7.0% or less, and/or a change in Young's modulus is ±18% or less, and/or a change in tensile strength is ±15% or less, and/or preferably, wherein the potting material comprises polyisocyanate and at least one diol and/or at least one polyol.
2. A ceramic filter element, comprising:
at least two oppositely arranged end surfaces having filtration channels, and
a surface covered with a potting material,
wherein the potting material is an epoxy or polyurethane comprising a thermoplastic plastic or a thermosetting plastic, has a depth of penetration into the filter element in the range of 0.24 mm to 3.0 mm, a shrinkage after curing of less than 1.24% and when cured a tensile strength in the range of about 2-65 MPa and a thermal expansion coefficient in the range of about 55-260×10⁻⁶/K, and/or preferably, wherein at least one end face is sealed tightly against fluid and/or gas by the potting material, and/or preferably, wherein comprising a plurality of ceramic filter elements mechanically connected by the potting material, and/or preferably, wherein the ceramic filter element has a segmental shape, monolithic shape, tubular shape, hollow fiber shape, or plate shape.
3. A method of forming a filter membrane module, the filter membrane module comprising at least one ceramic filter element made of a sintered, porous, ceramic structure, a potting material for potting the ceramic filter element, the potting material having an uncured state and a cured state; and a housing, wherein the potting material is a thermoplastic or a thermosetting plastic that in the cured state has a tensile strength in the range of about 2-65 MPa and a thermal expansion coefficient in the range of about 55-260×10⁻⁶/K, and a penetration depth of the potting material into the structure of the filter element is in the range of 0.24 mm to 3.0 mm, and a shrinkage after curing is less than 1.24%, the method comprising:
filling a vessel with a mixture including an epoxy or polyurethane comprising a thermoplastic plastic or a thermosetting plastic;
mechanically agitating the mixture for at least 5 minutes at 22° C.;
degassing the mixture at 60 mbar for about 8-10 minutes;
curing the mixture at 60° C. for 8 hours;
curing the mixture for 24 hours at room temperature, and/or preferably, wherein comprising transferring the degassed mixture to a clean mixing vessel, and/or preferably, wherein comprising mechanically agitating the mixture in the clean mixing vessel for 3-5 minutes, and/or preferably, wherein the mixture comprises diphenylmethane-4,4′-diisocyanate and polyether polyol, and/or preferably, wherein the mixture comprises methylenediphenyl diisocyanate, an aromatic isocyanate prepolymer, and polypropylene glycol, and/or preferably, wherein the mixture comprises diphenylmethane-2,4′-diisocyanate, diphenylmethan-4,4′-diisocyanate, diphenylmethane diisocyanate, and polyether polyol, and/or preferably, wherein the mixture comprises diphenylmethane-2,4′-diisocyanate, diphenylmethane-4,4′-diisocyanate, diphenylmethane diisocyanate, triethyl phosphate and diphenyl tolyl, and/or preferably, wherein the mixture comprises 1,1′-methylene-diphenyl-diisocyanate, 1,1′-methylenebis(4-isocyanatobenzene) homopolymer and vegetable oil, and/or preferably, wherein the mixture comprises a combination of Bisphenol A-epichlorohydrin resin and butane.

What is claimed is:

1. A filter membrane module, comprising:
at least one ceramic filter element made of a sintered, porous, ceramic structure;
a potting material for potting the ceramic filter element, the potting material having an uncured state and a cured state; and
a housing;
wherein the potting material is a thermoplastic or a thermosetting plastic that in the cured state has a tensile strength in the range of about 2-65 MPa and a thermal expansion coefficient in the range of about 55-260×10⁻⁶/K, and
a penetration depth of the potting material into the structure of the filter element is in the range of 0.24 mm to 3.0 mm, and a shrinkage after curing is less than 1.24%.

2. The filter membrane module of claim 1, wherein the potting material is an epoxide or polyurethane.

3. The filter membrane module of claim 1, wherein the potting material in the uncured state has a viscosity that is in a range of about 400-4500 mPa·s.

4. The filter membrane module of claim 1, wherein the potting material in the cured state has a Shore hardness in the range of about D10-D86.

5. The filter membrane module of claim 1, wherein the potting material in the cured state has a Young's modulus in the range of about 20-4000 MPa.

6. The filter membrane module of claim 1, wherein the potting material in the cured state has a glass transition temperature in the range of less than about 0° C. or greater than about 25° C.

7. The filter membrane module of claim 1, wherein the potting material has a pot life in the range of about 7-180 min.

8. The filter membrane module of claim 1, wherein the potting material in the cured state has an elongation in the range of about 1-10 or about 70-100.

9. The filter membrane module of claim 1, wherein the potting material in the cured state has a cohesive fracture behavior with respect to itself and other bonded materials.

10. The filter membrane module of claim 1, wherein after immersion of the potting material in the cured state in a fluid at a temperature of 55° C. for 18.5 days a change in mass is 5±2% or less, and/or a change in Shore hardness is ±22% or less, and/or a change in dimensions is ±7.0% or less, and/or a change in Young's modulus is ±18% or less, and/or a change in tensile strength is ±15% or less.

11. The filter membrane module of claim 1, wherein the potting material comprises polyisocyanate and at least one diol and/or at least one polyol.

12. A ceramic filter element, comprising:
at least two oppositely arranged end surfaces having filtration channels, and
a surface covered with a potting material,
wherein the potting material is an epoxy or polyurethane comprising a thermoplastic plastic or a thermosetting plastic, has a depth of penetration into the filter element in the range of 0.24 mm to 3.0 mm, a shrinkage after curing of less than 1.24% and when cured a tensile strength in the range of about 2-65 MPa and a thermal expansion coefficient in the range of about 55-260×10⁻⁶/K.

13. The ceramic filter element of claim 12, wherein at least one end face is sealed tightly against fluid and/or gas by the potting material.

14. The ceramic filter element of claim 12, comprising a plurality of ceramic filter elements mechanically connected by the potting material.

15. The ceramic filter element of claim 12, wherein the ceramic filter element has a segmental shape, monolithic shape, tubular shape, hollow fiber shape, or plate shape.

16. A method of forming a filter membrane module, the filter membrane module comprising at least one ceramic filter element made of a sintered, porous, ceramic structure, a potting material for potting the ceramic filter element, the potting material having an uncured state and a cured state; and a housing, wherein the potting material is a thermoplastic or a thermosetting plastic that in the cured state has a tensile strength in the range of about 2-65 MPa and a thermal expansion coefficient in the range of about 55-260×10⁻⁶/K, and a penetration depth of the potting material into the structure of the filter element is in the range of 0.24 mm to 3.0 mm, and a shrinkage after curing is less than 1.24%, the method comprising:
filling a vessel with a mixture including an epoxy or polyurethane comprising a thermoplastic plastic or a thermosetting plastic;
mechanically agitating the mixture for at least 5 minutes at 22° C.;
degassing the mixture at 60 mbar for about 8-10 minutes;
curing the mixture at 60° C. for 8 hours;
curing the mixture for 24 hours at room temperature.

17. The method of claim 16, further comprising transferring the degassed mixture to a clean mixing vessel.

18. The method of claim 16, wherein the mixture comprises diphenylmethane-4,4′-diisocyanate and polyether polyol.

19. The method of claim 16, wherein the mixture comprises methylenediphenyl diisocyanate, an aromatic isocyanate prepolymer, and polypropylene glycol.

20. The method of claim 16, wherein the mixture comprises a mixture selected from the group consisting of:
a) diphenylmethane-2,4′-diisocyanate, diphenylmethan-4,4′-diisocyanate, diphenylmethane diisocyanate, and polyether polyol;
b) diphenylmethane-2,4′-diisocyanate, diphenylmethane-4,4′-diisocyanate, diphenylmethane diisocyanate, triethyl phosphate and diphenyl tolyl;
c) 1,1′ -methylene-diphenyl-diisocyanate, 1,1′ -methylenebis(4-isocyanatobenzene) homopolymer and vegetable oil; and
d) a combination of Bisphenol A-epichlorohydrin resin and butane.
